(19) United States
(12) Patent Application Publication
(10) Pub. No.: US 2009/0006269 A1
(43) Pub. Date: Jan. 1, 2009

(54) Income Strategy Selector System

(76) Inventor: Alan Klayman, Lahaska, PA (US)

Correspondence Address: FOX ROTHSCHILD LLP;New York, 2000 Market Street, Tenth Floor, Philadelphia, PA, 19103, US

(21) Appl. No.: 11/771,012

(22) Filed: Jun. 29, 2007

(51) Int. Cl. G06Q 40/00

(52) U.S. Cl. 705/36 R

(57) ABSTRACT

An income strategy selector method and related system enable a user to select the most appropriate income strategy, or group of strategies based upon the personal investment characteristics of the user. A plurality of questions is presented to the user to determine the investment characteristics of the user. Based upon these characteristics, the strategies that would fit the characteristics of the user are selected, and these selected strategies are presented to the user in order of least risk to most risk. Strategies not selected are also presented to the user in order of least to most risk to give the user the opportunity to explore a larger universe of choices of income strategies.

### FIELD OF THE INVENTION

The present invention relates generally to financial planning and, more particularly, to a method and system that permits an investor to select one of a multiplicity of potential income strategies.

### BACKGROUND OF THE INVENTION

Many financial planners, brokers, advisors, insurance agents and the like provide investment advice, particularly retirement advice. Most of these advisors are familiar with income strategies, but mostly with the related investment products and services of their own particular field. For example, some financial planners concentrate only on loaded funds; others recommend only various combinations or types of mutual funds, while yet others may only suggest various types of money management services. Some, such as insurance agents, tend to stress the benefits of annuities to the exclusion of all other possible investment strategies, while yet others, such as bonds salespeople, recommend only fixed income strategies.

Because of the underlying and inherent biases of an advisor, which are a function of the products and services the advisor has to sell, the investment advice a client obtains from the advisor is generally limited to particular variations of the single investment strategy of choice of that advisor. In short, the client is being deprived of the opportunity to choose other possible income strategies that will give them different investment choices. Indeed, the default strategy of choice for most advisors is the market withdrawal strategy, which suffers from the inherent risk of the client running out of money before running out of time, and thus may not be suitable for many people.

Numerous applications exist that allow a person to select and tune a variation of a particular investment strategy. For example, U.S. Pat. No. 7,062,458, entitled “User Interface for a Financial Advisory System That Allows an End User to Interactively Explore Tradeoffs Among Input Decisions” by Maggioncalda et al. discloses a Monte Carlo simulator useful to tune investments when employing the market withdrawal strategy. By way of further example, U.S. Published Application No. 2006/0149651, entitled “Retirement Planning System and Method” by Charles D. Robinson discloses a specific type of strategy that attempts to include a lifetime annuity into an income strategy and an assumption of possible reduced income need as the user ages. Each of these represents a specific instance or type of income strategy. To date, however, there does not exist a method or related system that assists a client in the selection of the various types of income strategies that actually exist, rather than simply the selection of a specific version within a single strategy.

### SUMMARY OF THE INVENTION

Accordingly, the present invention provides a plurality of income strategy selection approaches that allow for selection and presentation of income strategies to a client based upon the investment characteristics of that client. Income strategies may include market withdrawal, spend down/grow back, income investments, and zero or more of these with a lifetime income option. In various embodiments, the spend down/grow back strategy can include shorter term spend down/grow back, longer term spend down/grow back variations, and combinations of strategies.

In a first embodiment, income strategies that are believed to be preferable to the client are presented. These strategies may be presented together as a group and ordered by risk. In a further embodiment, income strategies that may not be to the client's preference may also be presented, so that a client may maximally explore all possible income strategies. These strategies may be presented as a separate group and may also be ordered by risk.

The method includes first determining the investment characteristics and preferences of the client. The investment characteristics and preferences are then utilized to select at least one strategy from the plurality of potential income strategies. The client is provided the at least one selected strategy, and in certain embodiments the selected or “try these” strategies are presented in order of risk, from most conservative to least conservative.

In other embodiments, the potential income strategies that are not one of the at least one “try these” strategy are also provided as a separate group to the user in order according to risk.

In certain preferred embodiments, the investment characteristics and preferences of the client are determined by presenting to the client a plurality of predetermined questions related to the investment characteristics of the client, and then obtaining from the client a plurality of answers in response to the respective questions. In specific embodiments, the questions include a question adapted to determine if the client prefers only fixed or guaranteed investments; a question adapted to determine if the client prefers an income strategy with a lifetime income component; and a question adapted to determine if the client prefers investments that are substantially aligned with the movement of the stock and bond markets.

In other embodiments, the plurality of questions further include a question adapted to determine if the client prefers an income strategy that can be changed after a predetermined period of time, and a question adapted to determine if the client prefers a shorter period of time or a longer period of time for the predetermined time period.

Furthermore, various embodiments disclose a related computer system for assisting a client in the selection of at least one of a plurality of potential income strategies.

### BRIEF DESCRIPTION OF THE DRAWINGS

FIG. 1 is an flow chart of an embodiment method that allows a client to select one of a multiplicity of potential income strategies.

FIG. 2 is a flow chart depicting embodiment steps for determining the investment characteristics of a client.

FIG. 3 is a flow chart depicting embodiment steps for presenting to the client income strategies for consideration.

FIG. 4 is a block diagram of an embodiment computer system.

FIGS. 5-24 illustrate an embodiment user interface provided by the computer system of FIG. 4.

### DETAILED DESCRIPTION

An income strategy selector method, and related system, is generally described herein. Various embodiments are provided in the following as non-limiting examples, and certain terms are used in the description that may be usefully defined for a better understanding of these embodiments.

A “client” is typically an individual looking for financial advice. A “user” is typically the user of a computer system. In the instant disclosure, the terms “client” and “user” are interchangeable, as a user may be a client and vice versa.

An “income strategy” provides a means of turning investments into cash, and may be loosely thought of as a way of acquiring a steady paycheck, or spendable cash from the savings and investments a client has. An income strategy may incorporate one or more different types of investments, and hence one or more different investment strategies. Typically, in income strategy will dictate the possible investment choices, rather than the other way around. An investment strategy differs from an income strategy. An investment strategy is a method or technique to enhance the profits and/or minimize the losses associated with a portfolio. Many investment strategies are specific to a certain type or class of investment, whereas an income strategy will encompass many different classes or types of investments, based on that specific income strategy and not on the investments themselves. Once an income strategy is found that best fits the situation, risk profile, and lifestyle characteristics of a client to turn the client's savings and investments into spendable cash, then one can plug in the investments that fit best, and employ investment strategies to enhance the profits and minimize the losses for those investments within the income strategy.

The “investment characteristics” of a client may include physical, financial and psychological characteristics. Physical characteristics may include, for example, the potential longevity of the client, the age of the client, the health of the client, marital status, etc. Financial characteristics may include, for example, the current earned income of the client, the total net worth of the client, the current debts of the client and their respective types, their ability and willingness to work, other sources of income, the types of income sources they may have (pensions, social security, deferred compensation, inheritance, etc.), the timing of receiving this income, the type of accounts they possess (retirement vs. non-retirement), the tax implications of these accounts and any future income and so forth. The psychological characteristics may include, for example, the client's acceptance or aversion to market risk, the types of investments the client tends to prefer, the desire for investment flexibility, the length of time the client is willing to remain with a strategy before reevaluating and trying another, etc.

“Market withdrawal” is a class of income strategies characterized in that the client is selling investments from their portfolio to provide current income. When cash on hand will last for five years or less, due to the inherent risk of the markets (that is, how easy it is to lose money due to market volatility), the client is said to be using a Market Withdrawal Strategy. This is the most risky strategy a client can use. Every Money Management, Mutual Fund sales strategy, Stock Investment, Monte Carlo simulator, and linear calculator employs a Market Withdrawal Strategy. This type of strategy calculator tries to predict when the client will run out of money.

“Spend down/grow back” is a class of income strategies characterized in that the client puts enough money aside, typically for five to seven or more years, to spend; this gives the client five to seven or more years to grow their remaining assets so that, when it comes time to sell off investments (if necessary), the risk of losing money in those investments has decreased. For example, selling from investments every month correlates to a higher probability of losing money, while selling from investments every 14 years correlates to a lower probability of losing money. These strategies define the rate of return needed to grow back the money spent over a period of time. This awareness of the rate of return needed on investments allows the client to refine their investment strategy as time progresses. If the rate of return achieved is greater than needed, the client has more money in their savings and investments, can possibly take a higher income later, and may be able to leave a larger estate. If the rate of return achieved is less than needed the client may have to adjust their income down in the future. After the initial period of time has elapsed the client has the ability to pick a new strategy, or do it all over again. The spend down/grow back income investment strategy may include both long term (10-14 years, for example) and short term spend/down grow back strategies (5-7 years, for example). Short term may be for “n” years, and long term will be for some number of years in excess of “n.” “n” can be predetermined, or can be a function of when future income is expected. A client may choose a 7 year strategy due to the characteristics of that strategy, or may choose an 8 year strategy, because their income need is different for the next 8 years (e.g., 8 years from now social security payments start) A long term spend down/grow back strategy may be for a term of years that is twice as long as the comparable short term spend down/grow back strategy. In certain embodiments, as discussed below, a short term spend down/grow back strategy may be over a term of seven years, while a long term spend down/grow back strategy may have a term of 14 years. Other term values are, however, possible.

“Income investments” is a class of income strategies characterized in that the underlying securities in this strategy have a determined finite maturity, and upon that maturity the investor is guaranteed the corpus by the issuer. Such investments may include individual bonds, bank CDs, savings accounts, money market accounts, fixed deferred annuities, unit trusts, charitable trusts, irrevocable trusts, and other fixed income instruments. This is the most conservative strategy a client can use, i.e., least risky strategy, due to the nature of the guarantee of the issuer (e.g. the U.S. Government), and the lack of fluctuation in the final maturity of the investments. In this strategy the client cares less about the current value of their investment portfolio since they know what income they are receiving, and more about the final maturity of the investments in their portfolio. With bond mathematics, the rate of return equals the coupon payment, with an assumption that the coupon payment is reinvested at the same rate it is paying. For example, an 8% bond has a coupon payment of 8% and a reinvestment rate of 8%. In various embodiments, a more conservative assumption may be made, which is that unused payments that will be utilized to offset inflation at a future date are increasing at a rate consistent with money market and savings accounts. For example, an 8% bond pays a coupon of 8%, and the money that is not spent on current income needs is reinvested at 3%.

Any of the above income strategies may include an optional “lifetime income” component. A lifetime income component includes investments that pay out for the lifetime of the client. Such investments include fixed income annuities, variable income annuities, combination (fixed/variable) income annuities, reverse mortgages, charitable annuities, pooled income funds, charitable trusts, and other trusts that produce lifetime income. Lifetime income helps ensure that a client will not run out of money, but poses liquidity issues in many types of lifetime income instruments; it is therefore a choice the client should make. In certain embodiments, this option may be neither encouraged nor discouraged. It is, however, available made as a choice in either the client preferred strategy list (if chosen), or the remaining list of strategies.

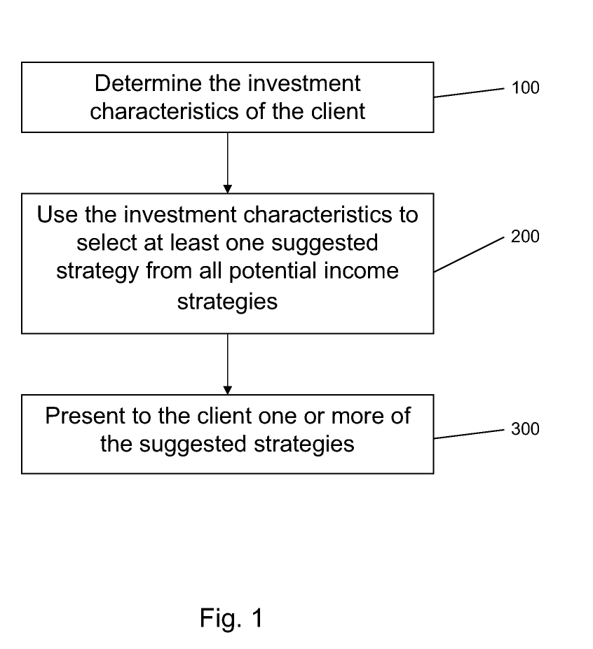

An embodiment income strategy selection method may present to a client as suggested strategies (which are henceforth termed “try these” strategies) what is deemed one or more of the most suitable of a plurality of potential income strategies, in which the most suitable strategies are selected based upon the investment characteristics of the client. The potential income strategies may include, in order of risk (from least risky to most risky) the income investments strategy, spend down/grow back strategies, and the market withdrawal strategy. The spend down/grow back strategies may include both long term and short term variations. Long term spend down/grow back may not necessarily be riskier then short term spend down/grow back strategies due to the length of time in which to grow assets, but is characterized as such due to the ability of the client to reevaluate their income strategy needs when choosing a shorter strategy. All of these income strategies may also include an optional lifetime income component, which may add an additional component of risk. In one embodiment, as shown in FIG. 1, the method broadly includes a first step 100 of determining the investment characteristics of a client. Once the investment characteristics are known, in a subsequent step 200 these investment characteristics are used to select at least one “try these” strategy selected from the plurality of potential income strategies. In step 300, at least one of the “try these” strategies is presented to the client.

In certain embodiments, the first step 100 of determining the investment characteristics of the client may include submitting questions to the client and obtaining corresponding answers from the client. This may comprise presenting to the client a plurality of questions, the answers to each of which provide information about the investment characteristics of the client. The questions may be used to determine, for example, if the client prefers only fixed or guaranteed investments; if the client prefers an income strategy with a lifetime income component; if the client prefers investments that are substantially aligned with the movement of the stock and bond markets; if the client prefers an investment strategy that can be changed after a term of years; and, if so, whether the client prefers a shorter term period or a longer term period. Of course, the questions may be presented in any suitable order.

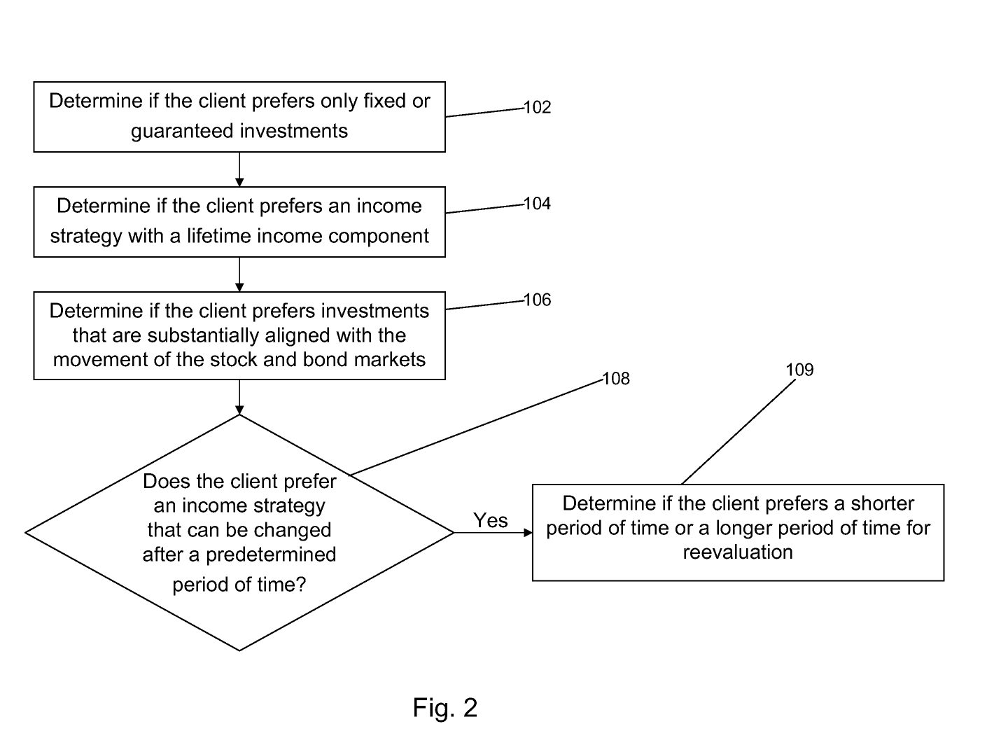

One embodiment method for determining the investment characteristics of the client is depicted in FIG. 2. By way of example, a first question 102 is used to determine if the client prefers an income investment strategy that uses only fixed or guaranteed investments. For example, this question may be posed as, “Would you prefer your strategy to used fixed or guaranteed investments only?” A preference for only fixed or guaranteed investments may indicate that the most conservative income strategy, the income investments strategy, is compatible with the investment characteristics of the client. Alternatively, if the client does not require fixed or guaranteed investments only, then this may indicate that such a conservative strategy may not be the only strategy compatible with the investment characteristics of the client.

A second question 102 may be presented to determine if the client should consider a lifetime component to whatever income strategy is eventually selected, which can offer real advantages after the client has passed his/her life or joint life expectancy, where life expectancy is the actuarial 50/50. That is, 50% of the population will live past that point, and 50% will not. For example, such a question may be posed as, “Do you have longevity in either your family, or in your spouse/partner's family?” Although no one can know in advance whether they will live long enough to enjoy such benefits, longevity in the family may increase the chances that the client, or the client's spouse or partner, will also enjoy a long life, and hence the benefits of a lifetime component.

A third question 106 may be presented to determine if the client prefers investments that tend to track the markets, such as the stock and bond markets. This question may be asked, for example, as “Do you want to have the income from your investments aligned with the movement of the stock and bond markets?” When investments track the market, the income or account value tends to go up; similarly, the income or account value tends to go down when the markets go down. Generally, when a client indicates that such market tracking is preferred, then this indicates that the most volatile, and hence risky market withdrawal strategy, may be compatible with the client's investment characteristics. The market withdrawal strategy generally works best for individuals who can absorb losses in their savings and investments and not have such losses immediately affect their income. When the client indicates that such market tracking is not preferred, then this tends to indicate that the market withdrawal strategy is not compatible with the investment characteristics of the client.

Finally, a fourth question 108 may be presented to determine if the client prefers a fixed income strategy that should not be changed, or a more flexible strategy that is designed to permit changes after a predetermined term, usually a term of years. This question may be presented as, “Do you want a strategy that you can reset/reevaluate in several years?” There are a number of income strategies that can be changed without severe financial consequences after a predetermined period of time. Clients may prefer such strategies for a number of reasons; for example, they may desire to change their strategies when social security checks begin arriving, or when a change of income is expected in a number of years. Many people prefer flexible strategies because such strategies allow them to reset and reevaluate their income strategies as their lives change; they don't feel obligated to a single methodology, and as a result have multiple investment options.

When the client indicates a preference for an income strategy that can be changed after a predetermined period of time, then a fifth question 109 may be presented that is designed to determine if the client would prefer a shorter period of time or a longer period of time for this predetermined time period. The question presented could be, for example, “Would you prefer a shorter period of time or a longer period of time to reset/reevaluate your strategy?” For those flexible income strategies that can be reset and reevaluated after a certain term, such as seven or 14 years, a shorter time period has both advantages and disadvantages. The advantages include the ability to reevaluate the strategy more frequently, and thus make more frequent changes when appropriate. A disadvantage, however, is that shorter time periods lose the advantage that time provides when growing money, such as the ability to smooth out temporary losses caused by volatility in the market. Longer time periods gain the advantage of smoothing out market volatility and hence the chance of losing money, but the advantage to reset/reevaluate the client situation is diminished compared to a shorter time period.

Once the investment characteristics of the client are known, these characteristics may be used to select one or more “try these” income strategies from the potential strategies. In step 200, the methodology of the present invention selects as “try these” strategies those potential income strategies that are most compatible with the investment characteristics of the client. By way of example, the following Table 1 provides a list of all possible combinations of answers to the five questions indicated above, and the resultant “try these” income strategies for each combination. Table 2 provides a legend for the acronyms used in Table 1.

TABLE 1

| FIO | ALN | LIC | FLX | LST | “Try these” strategies |
|---|---|---|---|---|---|
| N | N | N | N | N/A | None |
| N | N | N | Y | LT | LT SD/GB |
| N | N | N | Y | ST | ST SD/GB |
| N | N | Y | N | N/A | None |
| N | N | Y | Y | LT | LT SD/GB with LI |
| N | N | Y | Y | ST | ST SD/GB with LI |
| N | Y | N | N | N/A | MW |
| N | Y | N | Y | LT | LT SD/GB; MW |
| N | Y | N | Y | ST | ST SD/GB; MW |
| N | Y | Y | N | N/A | MW with LI |
| N | Y | Y | Y | LT | LT SD/GB with LI; MW with LI |
| N | Y | Y | Y | ST | ST SD/GB with LI; MW with LI |
| Y | N | N | N | N/A | II |
| Y | N | N | Y | LT | II; LT SD/GB |
| Y | N | N | Y | ST | II; ST SD/GB |
| Y | N | Y | N | N/A | II with LI |
| Y | N | Y | Y | LT | II with LI; LT SD/GB with LI |
| Y | N | Y | Y | ST | II with LI; ST SD/GB with LI |
| Y | Y | N | N | N/A | II; MW |
| Y | Y | N | Y | LT | II; LT SD/GB; MW |
| Y | Y | N | Y | ST | II; ST SD/GB; MW |
| Y | Y | Y | N | N/A | II with LI; MW with LI |
| Y | Y | Y | Y | LT | II with LI; LT SD/GB with LI; |
| | | | | | MW with LI |
| Y | Y | Y | Y | ST | II with LI; ST SD/GB with LI; |
| | | | | | MW with LI |

TABLE 2

| Acronym | Meaning |
|---|---|
| FIO | Fixed or guaranteed income investments only (Q.1) |
| LIC | Lifetime income component (Q.2) |
| ALN | Investments aligned with the market movement (Q.3) |
| FLX | Flexible strategy that can reset/reevaluate in |
| | several years (Q.4) |
| LST | Long or short term period to reevaluate/reset |
| | (Q.5) |
| LT | Long term |
| ST | Short term |
| SD/GB | Spend down/Grow back strategy |
| MW | Market withdrawal strategy |
| II | Income investment strategy |
| LI | Lifetime income component |

Of note in Table 1 are the first and fourth entries, both of which have a null set for the suggestion strategies, i.e., none of the potential strategies are compatible with the learned investment characteristics of the client. In the first entry, the client has indicated “no” to all questions, which has the effect of choosing no strategy at all; since they have not given a preference, there is no way to know what they favor. On the other hand, the fourth entry indicates a preference for lifetime income only investments, indicating an annuitizing of the entire portfolio, which is not recommended due to two underlying principles in various embodiments: 1) Never put all of your money in any single investment, and 2) you need liquidity on at least a portion of your assets to offset unexpected expenses. For example, if you want an income of $1000/month, if annuitize your entire portfolio to meet that need and then you run into unexpected expenses (your roof collapses, high medical bills, etc.), you do not have other investments nor the necessary liquidity (without penalty of time or loss of money) to adequately meet these needs. Also, it is noted that when the client indicates that a flexible income strategy is not desired, i.e., the client does not desire to reevaluate the income strategy after a predetermined period, then there is no need for asking the client if a long term or short term is preferred. Hence, whenever “FLX” in the fourth column of Table 1 is “N” there is no need to consider the corresponding “LST” entry, and hence that entry is labeled “N/A” as “not applicable.”

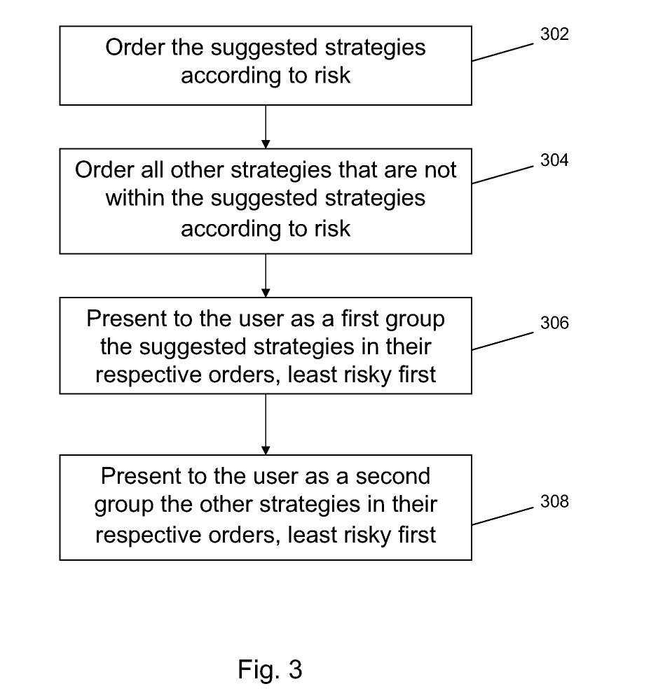

Once the “try these” strategy or strategies have been determined, they may then be presented to the client, in accordance with step 300. As indicated above, one of the financial characteristics of each of the potential income strategies is risk; some income strategies are inherently riskier than others. The “try these” strategies may therefore be presented to the client ordered by risk, such as by presenting the least risky of the “try these” strategies before the riskier “try these” strategies. The “try these” strategies may, in certain embodiments, be presented together as a group; all other potential income strategies, ordered by risk, may also be presented as another group. By presenting both the “try these” strategies, and all other potential strategies, the client is shown the entire universe of income strategies, and thus afforded a greater deal of choice. FIG. 3 is a flow chart of one embodiment method for presenting income strategies to the client. In step 302 the “try these” strategies are ordered by risk. All other potential income strategies that are not one of the “try these” strategies are also ordered by risk, indicated in step 304. Then, in step 306, the ordered list of “try these” strategies is presented to the client as a group, with the most conservative strategies presented first, and the riskiest strategies presented last. In step 308, the other income strategies are also presented together to the client as another group, also in order by risk. Of course, steps 304 and 308 need not be performed. Also, not all of the “try these” strategies need be presented to the client. By way of example, only the least risky of the “try these” strategies may be presented to the client. However, by presenting all possible strategies in their respective groups, and ordered by risk, the client is provided the most complete information on the income strategies they might want to consider.

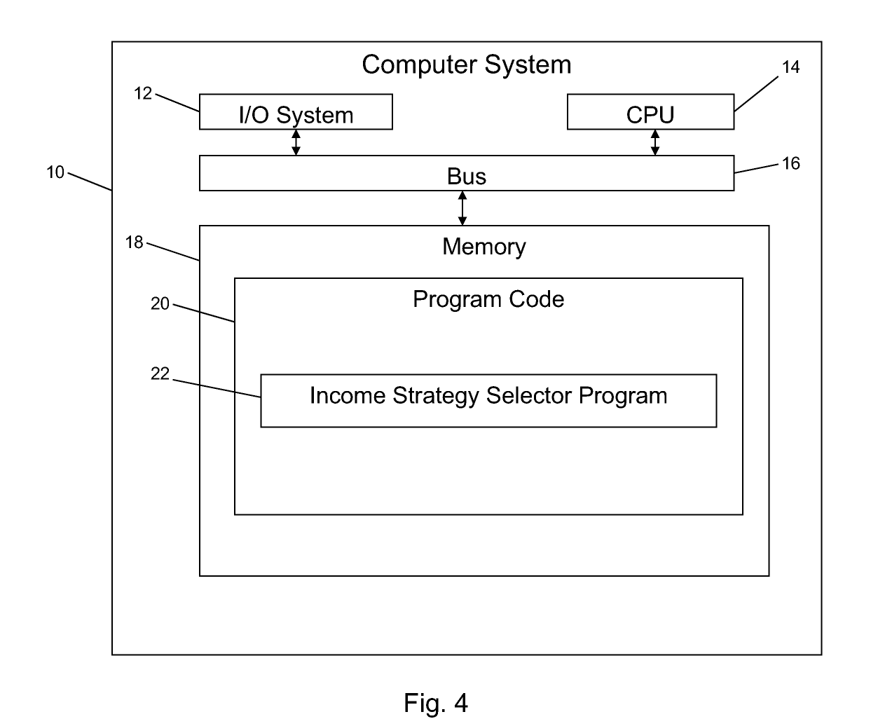

FIG. 4 depicts a diagram of a computer system 10 adapted to perform an embodiment method for assisting a user to select at least one of a plurality of potential income strategies. It will be appreciated that configurations for computer systems other than that shown in FIG. 1 may be employed. In particular, given the rapid rise of networking technologies, it will be appreciated that the computer system 10 may be readily adapted to provide a networked interface so that a remote user may access the computer system 10 to practice the embodiment method. This interface can be accessed by an intranet, the internet, or any other data trafficking system.

The computer system 10 includes an input/output (I/O) system 12, a central processing unit (CPU) 14, and a memory 18, which may be communicatively connected to each other via a bus 16, as known in the art, or by any other suitable means, including wireless connections. The I/O system 12 allows a user to provide input to the computer system 10, and in particular to the CPU 14, and also permits the CPU 14 to provide information to the user. The I/O system 12 typically includes any combination of a keyboard, mouse or other user input device, and also includes at least one output device, which is typically a video device but may also be a printer or even an audio device. Hence, any suitable input device and output device may be used within the I/O system 12, as known in the art, to provide information to a user, and to receive information from a user.

With specific reference to networked systems, it will be appreciated that both the input and output devices may be located on the client side, and that from the point of view of the server side, which may be the computer system 10, the I/O system 12 would essentially communicate with the user through a single device, which would be a networking device, be it an Ethernet adapter, a wireless transceiver, a modem or any other suitable networking hardware. Use of appropriate networking protocols, as known in the art, may enable the CPU 14, via the I/O device 12, to control a remote output device on the client side, and to receive input from a remote input device that is also on the client side. An exhaustive overview of the I/O system 12, and with particular reference to networked systems, is beyond the scope of this disclosure. Suitable programming techniques are, however, well known in the art, and may be readily employed by those of reasonable skill to implement the computer system 10 in both networked and standard (i.e., non-networked) configurations.

The memory 18 may be any suitable memory system as known in the art, and will typically include a combination of volatile and permanent memory, employing swapping techniques between the two as known. The memory 18 includes program code 20 that is executable by the CPU 14 to control the CPU 14 and thereby provide the operational functionality of the computer system 10. The program code 20 will typically contain an enormous amount of code that is well beyond the scope of this disclosure, such as an operating system and attendant device drivers, auxiliary programs for controlling the operating system, user applications, and the like. In particular, however, the program code 20 will include an income strategy selector program 22 that is adapted to perform an embodiment income strategy selection method.

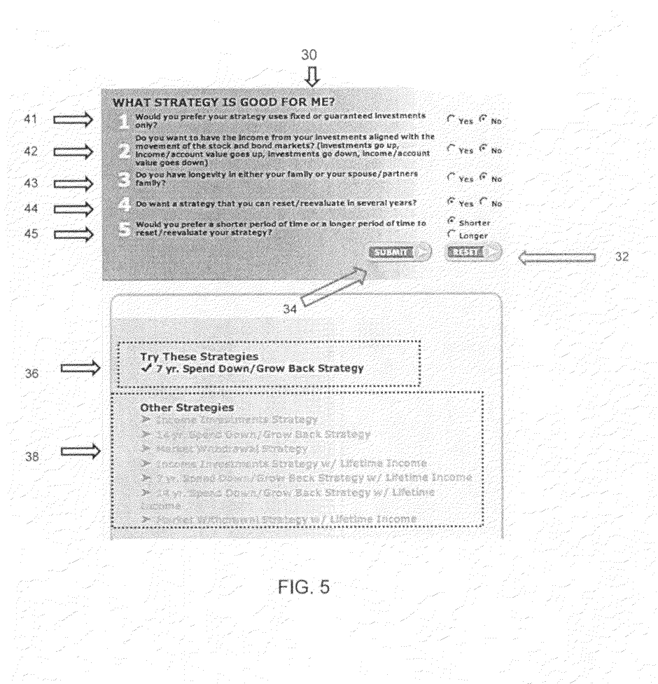

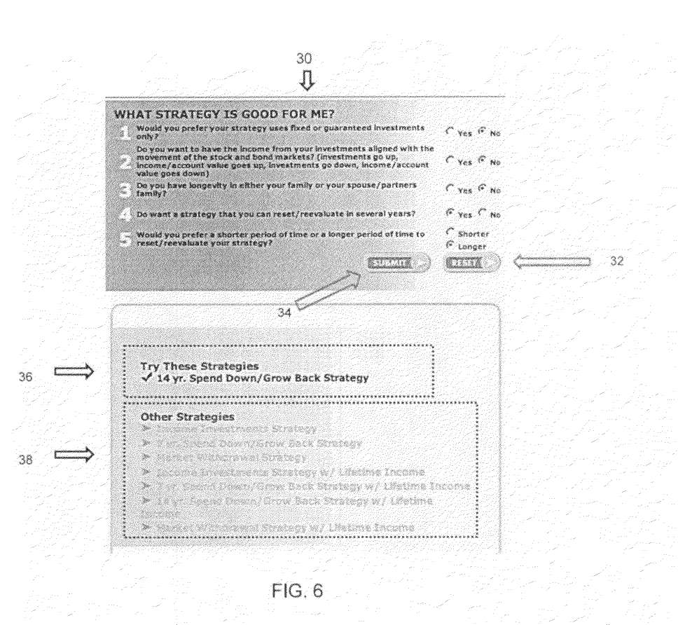

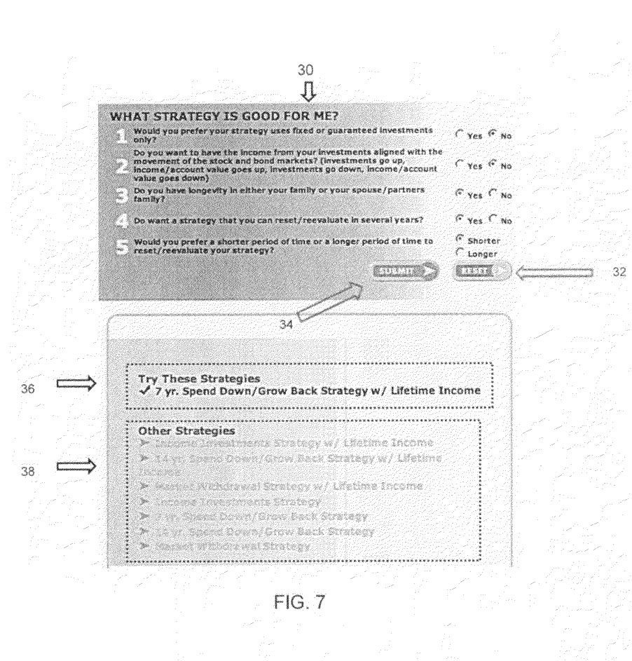

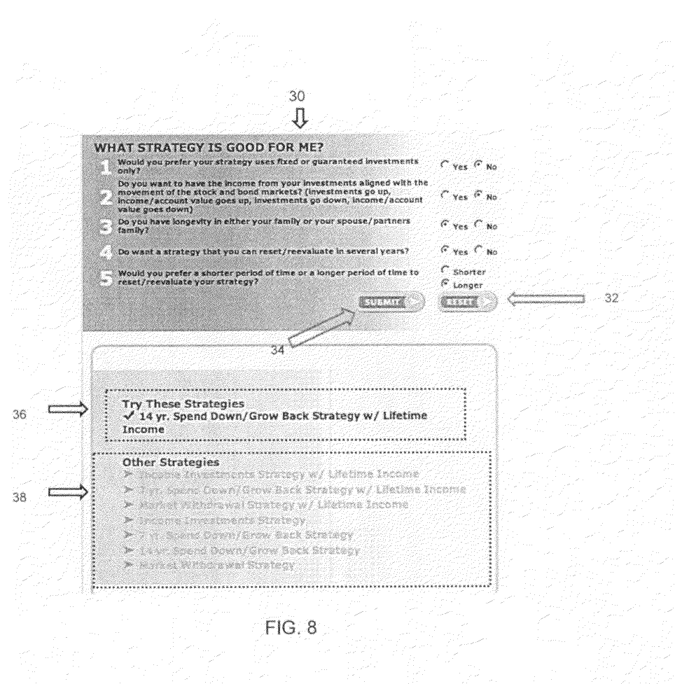

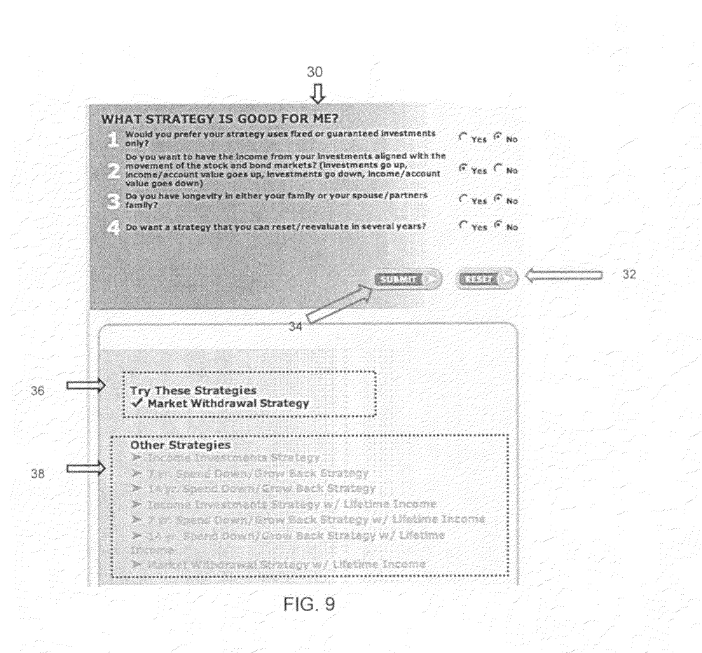

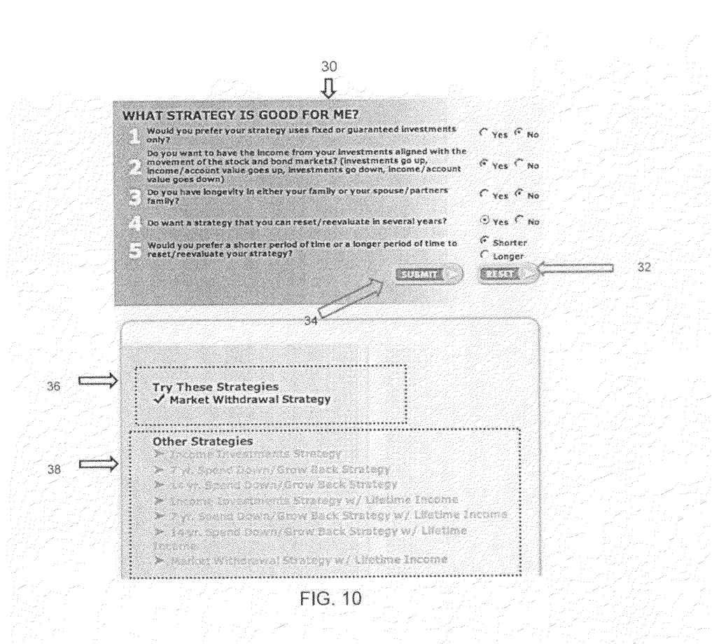

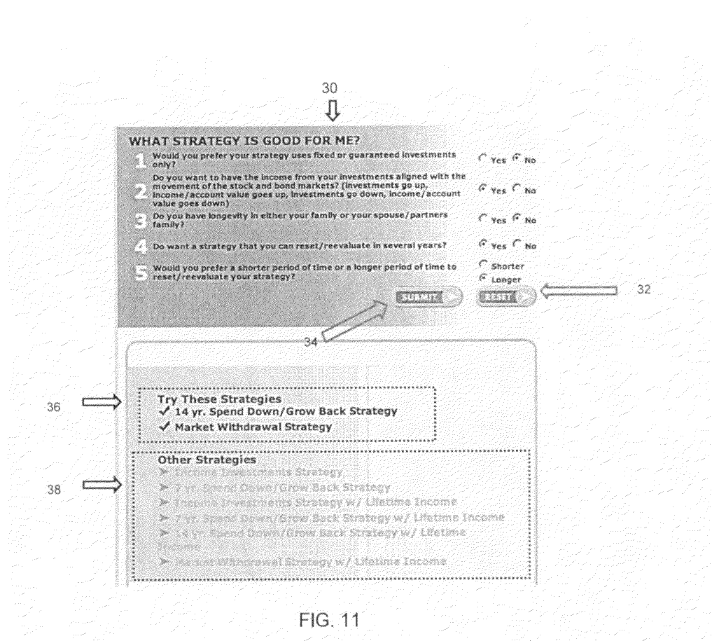

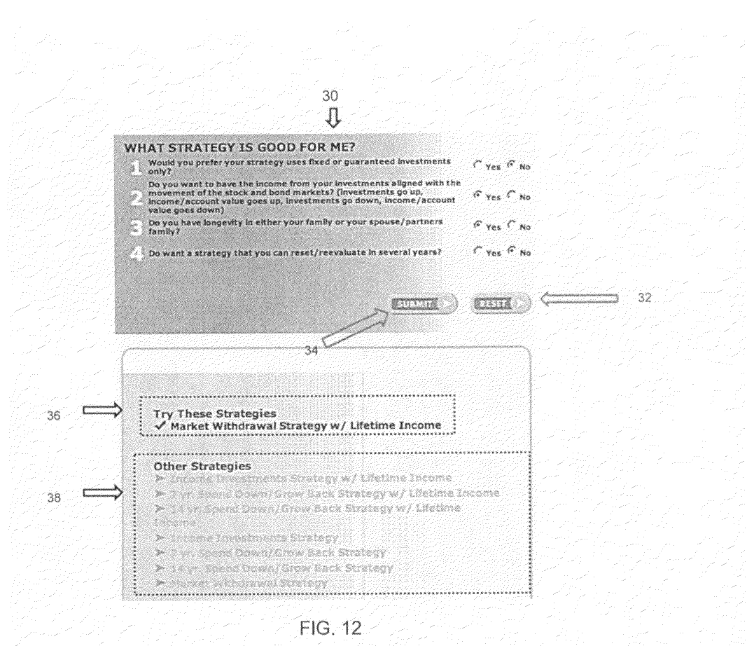

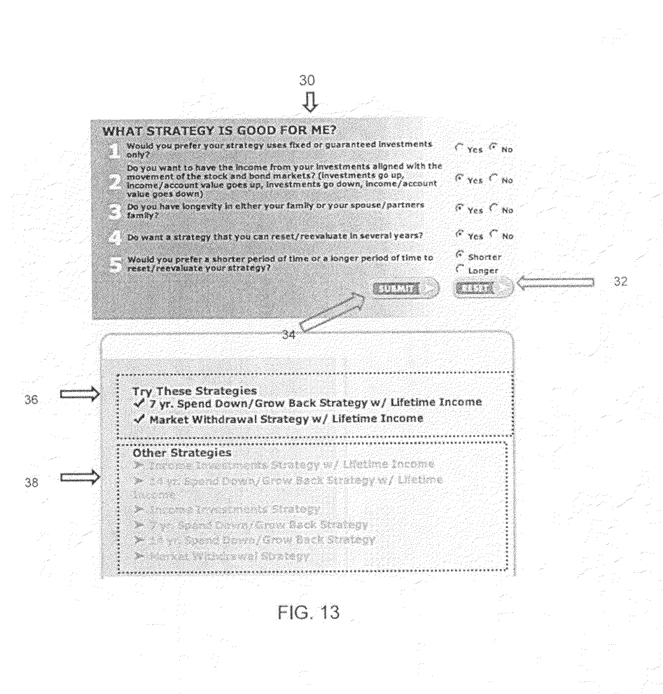

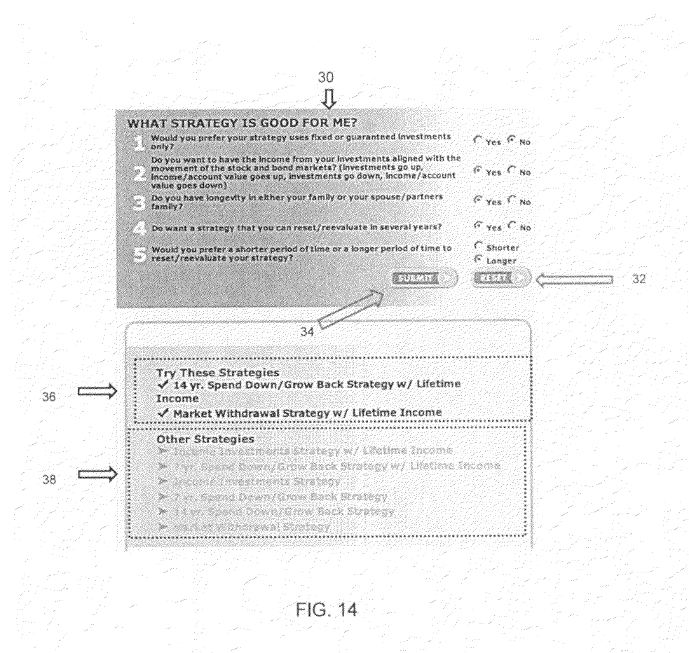

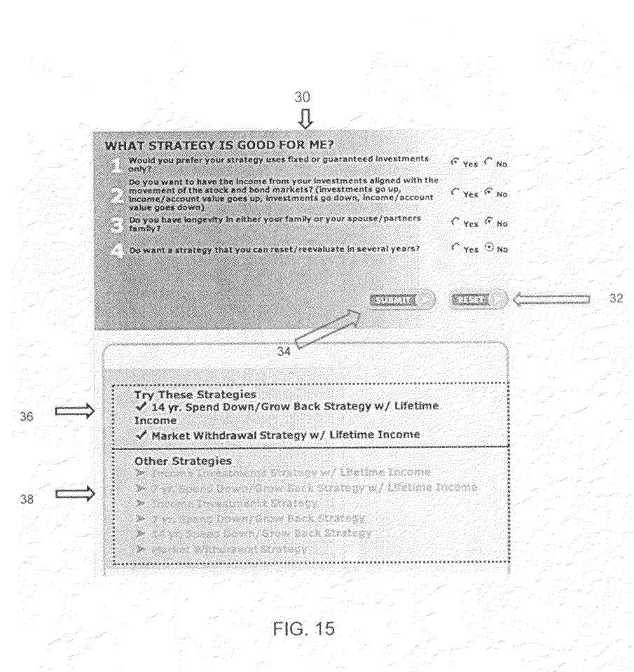

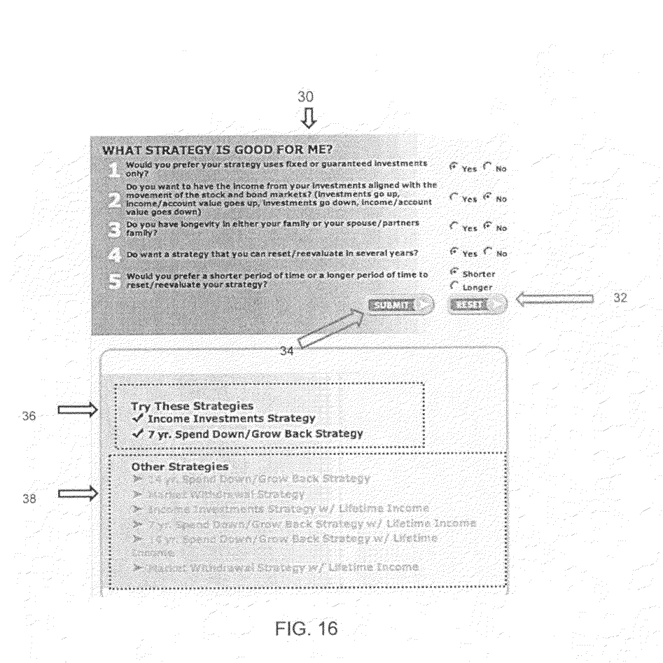

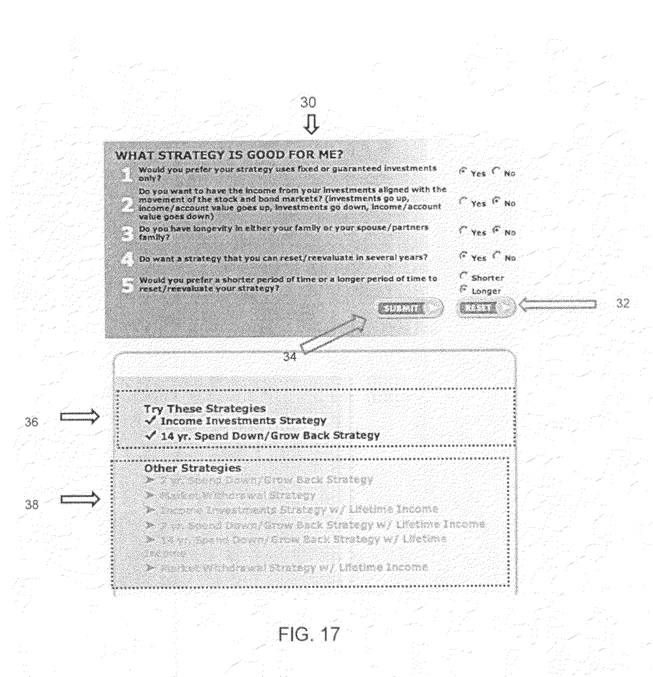

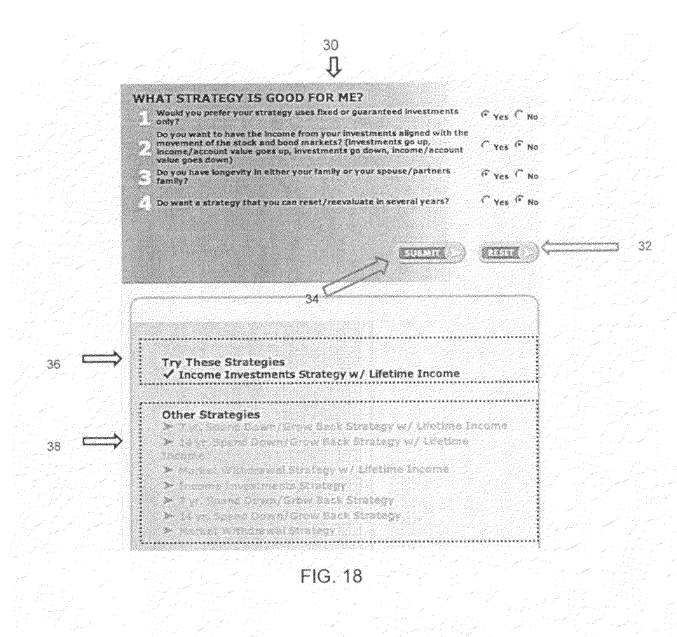

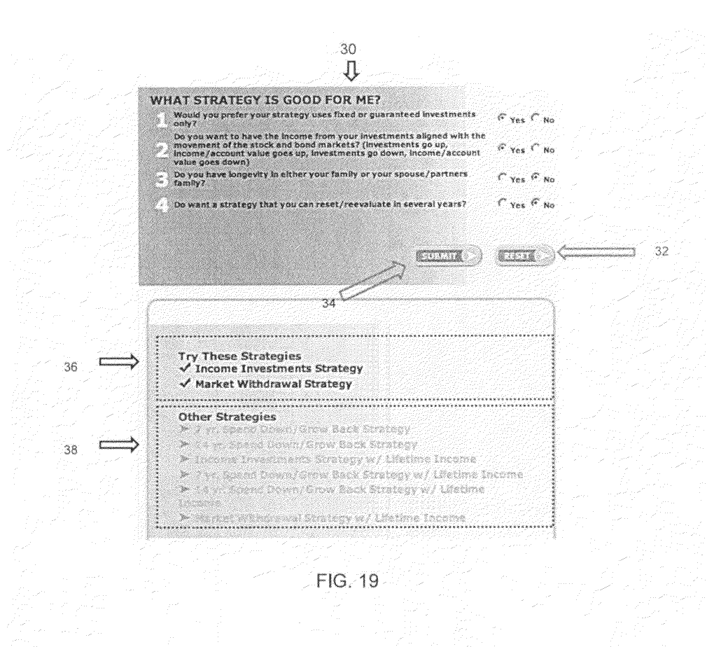

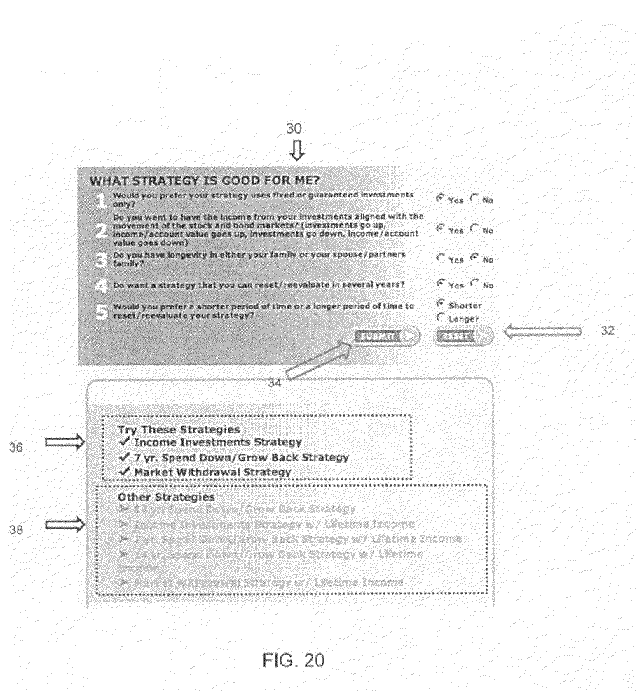

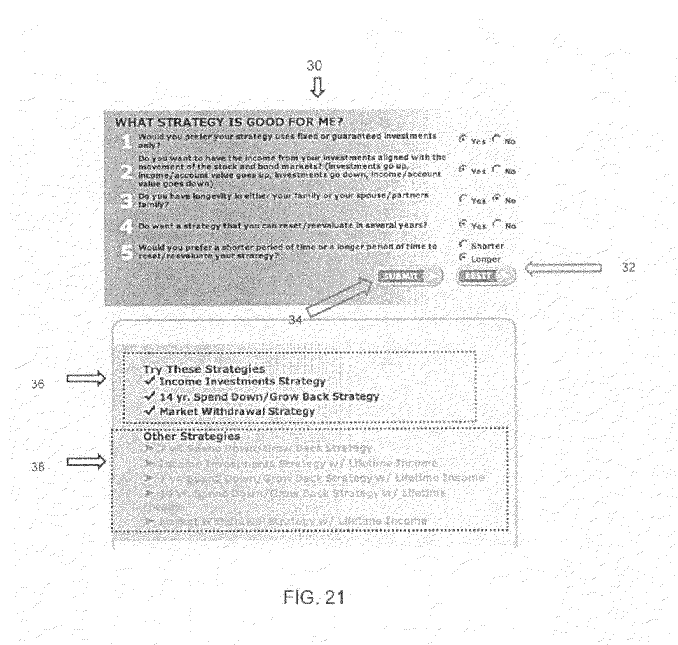

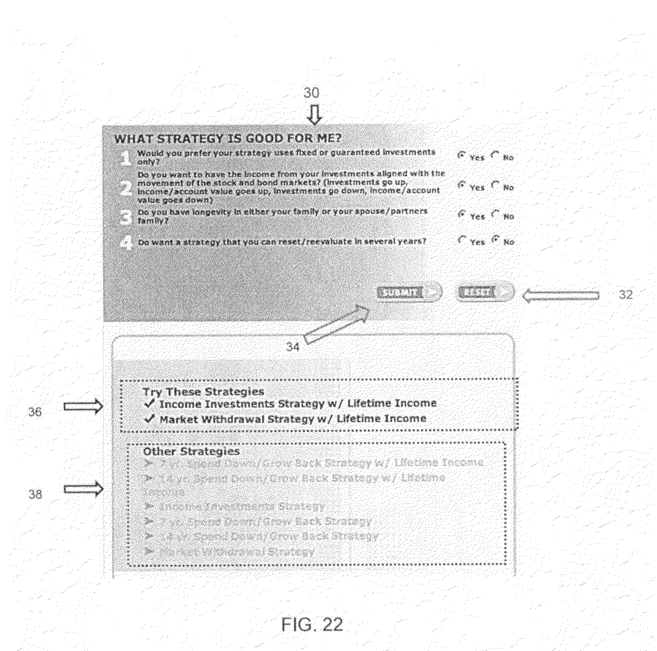

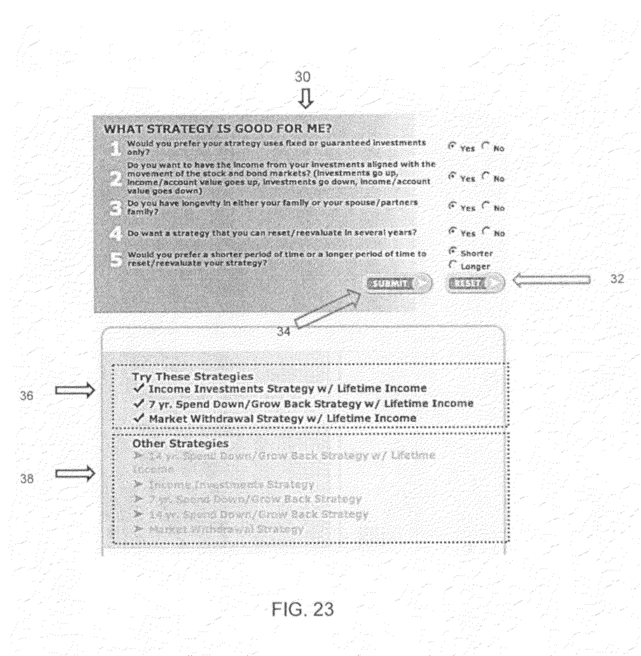

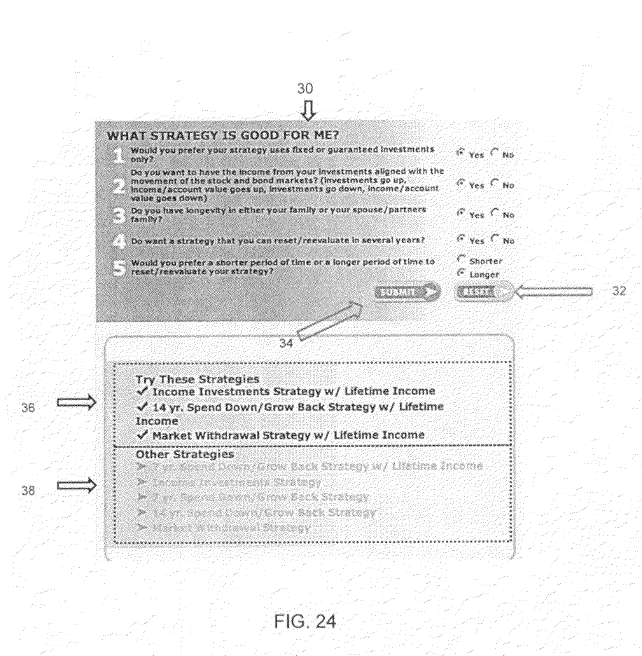

Screen shots of an embodiment user interface 30 as provided by the income strategy selector program 22 are shown in FIGS. 5-24. As shown, the strategy selector program 22 may control the I/O system 12 to present to the user a number of questions, each of which is designed to determine one or more investment characteristics of the user. A portion of the user interface 30 permits the user to answer these questions. For example, the program 22 may visually present to the user four, five, or more binary-type questions, each with an associated radio button that the user may select. The number of questions presented may vary, for example, based upon the answers received from earlier questions, as previously indicated.

As shown in FIGS. 5-24, the user interface 30 may include a reset button 32 that, when clicked upon by the user, causes the radio buttons to clear, or assume a default state. The user interface 30 may also include a submit button 34 that, when clicked, causes the program 22 to parse the investment characteristics according to the information obtained from the user interface 30. Table 1, for example, may be implemented by any known coding technique to thereby provide an embodiment program 22 that determines one or more “try these” income strategies based upon information obtained from the user interface 30. In the embodiment depicted in FIGS. 5 through 24, the program 22 presents all of the “try these” strategies together as a first group 36. Within the first group 36, the “try these” strategies may be listed in order of preference. This preference may be based, for example, on risk, from most conservative first to most risky last.

In certain embodiments, the program 22 may further present a second group 38 of income strategies. This second group 38 of income strategies may include all, or a portion of all potential income strategies that are not present within the first group 36. The second group 38, in combination with the first group 36, may thus allow the user to see the entire universe of all possible income strategies and thus offer the user the maximum amount of information possible. As with the first group 36, the second group 38 may be ordered, for example from least risky to most risky, as shown in the Figures.

With specific reference to FIG. 5, within the user interface 30 a first question 41 is provided to determine if the user prefers fixed investments only, and corresponds to the “FIO” column of Table 1. A second question 42 is used to determine if the user prefers investments that are aligned with the market, and corresponds to the “ALN” column of Table 1. A third question 43, when answered, provides information as to whether or not a lifetime income component would be compatible with the investment characteristics of the user, and corresponds to the “LIC” column in Table 1. A fourth question 44 assists in the determination of whether or not the user should consider an income strategy that can be reevaluated after a period of time, i.e., a flexible strategy, and corresponds to the “FLX” column of Table 1. Finally, the program 22 provides a fifth question 45 in response to a “Yes” answer to the fourth question 44, which is used to determine if the user should consider short term or long terms flexible strategies. In FIG. 5 the user answered the first three questions 41-43 as “No,” answered the fourth question 44 with a “Yes,” and the fifth question 45 with “Shorter.” This corresponds to the third row of data in Table 1, with the “‘try these’ strategies” entry of Short Term Spend Down/Grow Back, and hence in the corresponding “try these” strategy group 36, the program 22 indicates a seven year spend down/grow back strategy; in this embodiment, “short term” indicates a period of seven years, and long term indicates a period of 14 years. All other possible income strategies other are then listed as a separate group 38, ordered by risk.

Similar results and correlations with Table 1 may be observed in the remaining FIGS. 5 to 24. In each case, the questions 41-45 select a row within Table 1, and the program 22 may provide to the user as a group 36 of “try these” income strategies the “‘try these’ strategies” found in that row, which are compatible with the investment characteristics of the user. All other strategies not present in the “‘try these’ strategies” entry may be presented as a separate group 38.

It will be appreciated that the income strategy selector program 22 may be stored on a computer readable media, such as a magnetic media (floppy disk, hard disk, tape or the like), optical media (CD, DVD, etc.) or electronic media (flash memory sticks, ROM, etc.). Using this computer readable media, the selector program 22 may be installed onto (i.e., loaded into the memory of) other computer systems for execution, as known in the art. The income strategy selector program 22 may be stored in a compressed or otherwise encoded format on the computer readable media and later decompressed or decoded when installed onto the host computer for execution, as known in the art.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims. It should be appreciated that different income strategies and investments that are variations of those found within the context of this invention are embodied within the nature, logic and guiding principles of the invention.

What is claimed is:

1. A method for assisting a client to select at least one of a plurality of potential income strategies, the method comprising:
determining investment characteristics of the client;
utilizing the investment characteristics to generate at least one strategy selected from the plurality of potential income strategies; and
presenting to the client the at least one strategy;
wherein the plurality of potential income strategies includes market withdrawal, spend down/grow back, income investments, any zero or more of these with a lifetime income component, and combinations thereof.

2. The method of claim 1 wherein the spend down/grow back strategy includes shorter term spend down/grow back, and longer term spend down/grow back.

3. The method of claim 1 wherein each of the at least one strategy is presented in order according to risk.

4. The method of claim 3 further comprising presenting as a separate group to the user in order according to risk each of the potential income strategies that are not one of the at least one strategy.

5. The method of claim 1 wherein determining the investment characteristics of the client comprises:
presenting to the client a plurality of questions related to the investment characteristics of the client; and
obtaining from the client a plurality of answers in response to the respective questions.

6. The method of claim 5 wherein the plurality of questions include:
a question adapted to determine if the client prefers only fixed or guaranteed investments;
a question adapted to determine if the client prefers an income strategy with a lifetime income component; and
a question adapted to determine if the client prefers investments that are substantially aligned with the movement of the stock and bond markets.

7. The method of claim 6 wherein the plurality of questions further comprise:
a question adapted to determine if the client prefers an income strategy that can be changed after a predetermined period of time; and
a question adapted to determine if the client prefers a shorter period of time or a longer period of time for the predetermined time period.

8. A computer system adapted to perform the method of claim 1.

9. A computer system for at least assisting a user to select at least one of a plurality of potential income strategies, the computer system comprising:
a processor;
an input/output (I/O) system in communications with the processor and adapted to obtain information from the user and provide information to the user; and
memory in communications with the processor, the memory comprising program coded executable by the processor to perform the following steps:
controlling the I/O system to provide the user a plurality of questions adapted to determine investment characteristics of the user;
obtaining from the I/O system a plurality of answers in response to the respective questions;
utilizing the answers to select at least one strategy selected from the plurality of potential income strategies; and
controlling the I/O system to provide the user the at least one strategy;
wherein the plurality of potential income strategies includes market withdrawal, spend down/grow back, income investments, any zero or more of these with a lifetime income option, and combinations thereof.

10. The computer system of claim 9 wherein the spend down/grow back strategy includes shorter term spend down/grow back, and longer term spend down/grow back.

11. The computer system of claim 9 further comprising controlling the I/O system to provide the user each of the at least one strategy in order according to risk.

12. The computer system of claim 11 further comprising controlling the I/O system to provide the user as a separate group in order according to risk each of the potential income strategies that are not one of the at least one strategy.

13. The computer system of claim 9 wherein the plurality of questions include:
a question adapted to determine if the user prefers only fixed or guaranteed investments;
a question adapted to determine if the user prefers an income strategy with a lifetime income component; and
a question adapted to determine if the user prefers investments that are substantially aligned with the movement of the stock and bond markets.

14. The computer system of claim 13 wherein the plurality of questions further comprise:
a question adapted to determine if the user prefers an income strategy that can be changed after a predetermined period of time; and
a question adapted to determine if the user prefers a shorter period of time or a longer period of time for the predetermined time period.

15. A computer-readable media comprising the program code of claim 9.
